(19) United States
(12) Patent Application Publication
(10) Pub. No.: US 2008/0165672 A1
(43) Pub. Date: Jul. 10, 2008

(54) Joint channel estimation and data detection method for STBC/OFDM systems

(75) Inventors: Meng-Lin Ku, Bade City (TW); Chia-Chi Huang, Hsinchu City (TW)

Correspondence Address: BUCKNAM AND ARCHER, 1077 NORTHERN BOULEVARD, ROSLYN, NY, 11576, US

(73) Assignee: National Chiao Tung University, Hsinchu (TW)

(21) Appl. No.: 11/805,823

(22) Filed: May 24, 2007

(30) Foreign Application Priority Data
Jan. 5, 2007 (TW) 096100474

(51) Int. Cl. H04J 11/00

(52) U.S. Cl. 370/208

(57) ABSTRACT

The present invention provides a joint channel estimation and data detection method for STBC/OFDM systems, comprising the following steps: a preliminary step, in which, after passing the received signals through an OFDM demodulator, frequency-domain signals R̅₁[k] and R̅₂[k] of the complementary-coded pilot preambles in two successive OFDM symbol times, as well as two successive OFDM data symbols R₁⁽ⁱ⁾[k] and R₂⁽ⁱ⁾[k] at the ith time slot, are obtained; an initial step for setting up the predetermined number Nₚ of the channel path, using complementary-coded pilot preambles to estimate the channel impulse response, then using this estimation result of the channel impulse response to calculate a path selective set S_{m,}, and furthermore, in accordance with the path selective set S_{m,} determining the number Lₘ of the selected paths and the excess delay τ_{m,l} of the selected path, and then calculating the initial channel state information vector y^{(1,0)} and the Hessian matrix F; a tracking step, in which the initial value v of the recursion index is set to 1 at first, and the maximum number of recursion is set to V; if the index v of recursion is 1, use sparse pilot subcarriers to calculate channel state information Ĥₘ[k], and calculate a searching direction vector Ψ that is obtained by using the sparse pilot subcarriers and then calculate a searching direction vector

g^{(i,v)}=μγΨ⁽ⁱ⁾⁺⁽1−μ)(F+λI_{2(L}_{₁}_{+L}_{₂}₎)⁻¹∇ f(y^{(1,0)})

if the index of recursion is not equal to 1, calculate the searching direction vector as g^{(i,v)}=(F+λI_{2(L}_{₁}_{+L}_{₂}₎)⁻¹∇ f(y^{(i,v-1)}); next, update the channel state information vector by y^{(i,v)}=y^{(i,v-1)}−g^{(i,v)}, and increase the index of recursion by 1; if the index v of recursion is less than or equal to V, repeat the searching of the direction vector; finally, take the channel state information estimated at this time slot to be the initial value of the channel state information at the next time slot, i.e. y^{(i+1,0)}=y^{(i,V)}.

### FIELD OF THE INVENTION

The present invention relates to a channel estimation method for wireless communication, and in particular relates to a channel impulse response estimation method for space-time block codes/orthogonal frequency division multiplexing (STBC/OFDM) systems as well as a method which utilizes data subcarriers and sparse pilot subcarriers for tracking channel variations under a high vehicular speed and large delay spread environment.

### BACKGROUND OF THE INVENTION AND PRIOR ART

Currently, the development of mobile communication is stepping toward much higher data transmission rate; however, in a single carrier system, the data transmitted in high rate may cause inter-symbol interference (ISI) in received signals due to the influence of multipath channels so that the equalization of the receiver may become much more complicated. Presently, a variety of systems which utilize orthogonal multicarrier transmission such as an orthogonal frequency division multiplexing (OFDM) technique, are capable of resisting ISI caused by the multipath channels, and furthermore, because the subcarriers are mutually orthogonal, the use of the frequency spectrum can be much more effective.

Generally, when a signal having high transmission rate is transmitted via a multipath channel to a receiver, the received signal may suffer from the ISI phenomena caused by the channel path delay; therefore the channel equalization may become much more complicated. However, in OFDM systems, the problems of ISI can be overcome by appending an appropriate guard interval which is larger than the maximal time delay of a channel, in front of each OFDM symbol.

Although the performance of a system can be improved by using multiple-antenna diversity techniques, in mobile communication, however, the number of receive antennas of a mobile station (such as a cellular phone), because of the limitation on power consumption, size, and production cost, can not be arbitrarily increased in order to obtain performance improvement. Therefore, in October 1998, Alamouti proposed a simple STBC transmission diversity technique to improve the performance of the system. In Alamouti's paper, it is mentioned that it is possible to use two transmit antennas and one receive antenna to have the same diversity order as a maximum ratio combining (MRC) with two receive antennas, and furthermore, this method can be easily extended to the case of two transmit antennas plus M receive antennas thus providing a diversity order of 2M.

Nevertheless, the aforementioned STBC technique is only applicable to a flat fading channel and is usually subject to an environment with a small path delay spread. For a wireless communication environment with a large path delay spread, since the coherent bandwidth of a channel becomes smaller than the signal bandwidth, the channel is frequency selective. However, every sub-channel may appear to be flat by means of extending the symbol duration in a cyclic prefix-OFDM system.

In wireless communication, it is a trend of future mobile service that the data transmission rate must be increased in order to provide a better voice quality and the ability of real-time multimedia transmission. For this purpose, some has combined a STBC technique with an OFDM system, called an OFDM system using orthogonal coding of STBC, or abbreviated as STBC-OFDM.

For the prior arts of channel estimation for OFDM systems, they can be divided into three categories: (1) pilot-aided channel estimation method; (2) data decision feedback channel estimation method, and (3) blind channel estimation. The following is a list of the prior arts and papers relevant to the present invention, whereas the pros and cons of the prior arts will be discussed subsequently.

### 1. PRIOR ARTS

[A1] “Channel Estimation for Orthogonal Frequency Division Multiplexing Systems,” Sep. 1, 2004, R.O.C. Laid-Open Patent Application, No. 200417166.
[A2] “High Doppler Frequency Channel Estimation for OFDM Multiple Antenna System,” Jul. 1, 2006, R.O.C. Laid-Open Patent Application, No. 200623747.
[A3] “Method and Apparatus for Channel Estimation in OFDM System,” Sep. 1, 2005, R.O.C. Patent Bulletin, No. I239179.
[A4] “Channel Estimation Method, Receiving Method and Receiver for OFDM Signals,” Oct. 1, 2004, R.O.C. Laid-Open Patent Application, No. 200420053.
[A5] “Channel Estimation in a Communication System,” Feb. 7, 2006, U.S. Patent Bulletin, U.S. Pat. No. 6,996,195.
[A6] “Pilot-aided Channel Estimation for OFDM in Wireless System,” Nov. 25, 2003, U.S. Patent Bulletin, U.S. Pat. No. 6,654,429.
[A7] “Method and Apparatus for Channel Estimation with Transmit Diversity,” Feb. 8, 2005, U.S. Patent Bulletin, U.S. Pat. No. 6,853,689.
[A8] “Method and Apparatus for Channel Estimation for Multicarrier Systems,” Dec. 12, 2001, U.S. Patent Bulletin, U.S. Pat. No. 6,327,314.
[A9] “Iterative Maximum Likelihood Channel Estimation and Signal Detection for OFDM Systems,” April 11, U.S. Patent Bulletin, U.S. Pat. No. 7,027,519.
[A10] “Decision Feedback Channel Estimation and Pilot Tracking for OFDM Systems,” May 2, 2006, U.S. Patent Bulletin, U.S. Pat. No. 7,039,004.
[A11] “Method and Apparatus for Channel Estimation,” Jun. 24, 2006, U.S. Patent Bulletin, U.S. Pat. No. 6,990,061.

### 2. OTHER PUBLISHED REFERENCES

[B1] J. J. Vands Beek, O. Edfors, M. Sandell, S. K. Wilson, and P. O. Borjeson, “On Channel Estimation in OFDM Systems,” in Proc. 45th IEEE on Vehicular Technology Conference, July 1995, pp. 815-819.
[B2] J. J. Vands Beek, O. Edfors, M. Sandell, S. K. Wilson, and P. O. Borjeson, “OFDM Channel Estimation with Singular Value Decomposition,” in Proc 46th IEEE Vehicular Technology Conf., April, 1996, pp. 923-927.
[B3] Y. Li, L. J. Cimini, Jr., and N. R. Sollenberger, “Robust Channel Estimation for OFDM Systems with Rapid Dispersive Fading Channels,” IEEE Trans. on Comm., Vol. 46, No. 7, July 1998.
[B4] Kyung Seung Ahn and Heung Ki Baik, “Training-Based Channel Estimation and Equalization for Space-Time Block-Coded Systems over Frequency-Selective Fading Channels,” in Proc. 60th IEEE Vehicular Technology Conf., September 2004, pp. 1748-1752.
[B5] Y. Gong and K. B. Letaief, “Low Complexity Channel Estimation for Space-Time Coded Wideband OFDM Systems,” IEEE Trans. Wireless Commun., Vol. 2, No. 5, pp. 876-882, September 2003.
[B6] K. F. Lee and D. B. Williams, “A Multirate Pilot-Symbol-Assisted Channel Estimator for OFDM Transmitter Diversity Systems,” in Proc. Acoustics, Speech, and Signal Processing, ICASSP 2001, May 2001, pp. 2409-2412.
[B7] Jianxin Guo, Daming Wang and Chongsen Ran, “Simple Channel Estimator for STBC-Based OFDM Systems,” IEEE Electronics Letters, Vol. 39, No. 5, pp. 445-447, March 2003.
[B8] Meng-Lin Ku and Chia-Chi Huang, “A Complementary Codes Pilot-Based Transmitter Diversity Technique for OFDM Systems,” IEEE Trans. Wireless Commun., Vol. 5, No. 3, pp. 504-508, March 2006.
[B9] Y. Li, N. Seshadri, and S. Ariyavisitakul, “Channel Estimation for OFDM Systems with Transmitter Diversity in Mobile Wireless Channels,” IEEE J. Select. Areas Commun., Vol. 17, No. 3, pp. 461-471, March 1999.
[B10] Y. Li, “Simplified Channel Estimation for OFDM Systems with Multiple Transmit Antennas,” IEEE Trans. Wireless Commun., Vol. 1, No. 1, pp. 67-75, January 2002.
[B11] H. Minn, D. I. Kim and V. K. Bhargava, “A Reduced Complexity Channel Estimation for OFDM Systems with Transmit Diversity in Mobile Wireless Channels,” IEEE Trans. Commun., Vol. 50, No. 5, pp. 799-807, May 2002.
[B12] M. Enescu and V. Koivunen, “Time-Varying Channel Tracking for Space-Time Block Coding,” in Proc. 55th IEEE Vehicular Technology Conf., May 2002, pp. 294-297.
[B13] Kyung Seung Ahn and Heung Ki Baik, “Decision Feedback Detection for Space-Time Block Coding over Time-Selective Fading Channels,” in Proc. Personal, Indoor and Mobile Radio Commun., PIMRC 2003, September 2003, pp. 1983-1987.
[B14] P. Stoica and G. Ganesan, “Space-Time Block-Codes: Trained, Blind and Semi-Blind Detection,” in Proc. Acoustics, Speech, and Signal Processing, ICASSP 2002, pp. 1609-1612.
[B15] E. Beres and R. Adve, “Blind Channel Estimation for Orthogonal STBC in MISO System,” in Proc. IEEE GLOBECOM'04, November 2004, pp. 2323-2328.

### (1) As to the Pilot-Aided Channel Estimation Method:

In the prior arts [A1] to [A8] and [B1] to [B11], on the one hand, time-domain pilot symbols or frequency-domain pilot subcarriers are used to estimate a channel. On the other hand, in the prior arts [A1] to [A3], [B4] to [B8] and [B10], pilot signal transmission methods for multiple-input-multiple-out (MIMO) systems are designed. Generally speaking, transmission of the pilot signals must satisfy the Nyquist sampling rate; that is, the duration of the pilot symbol inserted in time domain must be smaller than or equal to one half of channel coherent time and the duration of the pilot subcarrier inserted in frequency domain must be smaller than or equal to one half of channel coherent bandwidth. Therefore, in an environment having a higher vehicular speed and a larger coverage (i.e., larger channel path delay), the data transmission rate will be substantially reduced by adopting a method that uses pilot signals to estimate the channel. On the other hand, in the prior arts [A2] and [B8], data signals and pilot signals are transmitted simultaneously. This method will not reduce the efficiency of the bandwidth usage, but an additional interference cancellation technique must be used in the receiver in order to obtain channel estimation.

Besides, some of the prior arts may use the channel correlation in time domain such as the prior art [B1], channel correlation in frequency domain such as prior art [B2], or simultaneously use the time-domain and frequency-domain correlations[A8], [B3], [B10], [B11] to improve the bit error rate (BER). However, under a general condition, the statistical characteristic of the channel correlation is difficult to derive directly; therefore, in the prior art [A5], a multipath energy distribution of instantaneous received signals is used in place of the statistical characteristic of the channel. However, it is noted that the performance of this method may be degraded in a high vehicular speed environment because in this case the channel variations may change very fast. Besides, for the method that utilizes the channel correlation, it is generally necessary to compute an inverse matrix, which has high computational complexity. In the prior art [B10], a special pilot signal has been designed to prevent the computation of the inverse matrix in order to reduce the computational complexity.

### (2) Decision Feedback Channel Estimation Method:

In the prior arts [A8] to [A11] and [B12], [B13], decision data is used to estimate a channel or track the variation of a channel. This method usually possesses a higher efficiency for the bandwidth usage, but may suffer from the problem of data decision error propagation, resulting in an inaccurate channel estimation, especially in a high vehicular speed environment. In the prior arts [A9] and [A11], a recursive maximum likelihood channel estimation and data detection method is used to achieve the goal of channel tracking, but this method is still a sub-optimal method, and it does not perform well in a high vehicular speed environment. In the prior arts [B12] and [B13], three types of recursive channel estimation or tracking methods were proposed. The first method is a Least Mean Square (LMS) method, which has a low complexity but can only be appropriately used in a low vehicular speed environment; besides, this method converges relatively slowly. The second method is a Recursive Least Square (RLS) method. Although the RLS method has higher complexity than the LMS method, it is well suitable for using in a higher vehicular speed environment, and has a higher convergent speed than the LMS method. The third method is a Kalman Filtering method. Although this method has the highest complexity among the three methods, it has the best performance in the BER. Nevertheless, for all of the three methods, it is necessary to retransmit pilot signals in a prescribed time interval in order to prevent the occurrence of the channel tracking slip (i.e., lost lock). Transmission of pilot signals may cause an 8% loss in the efficiency of the bandwidth usage.

### (3) Blind Channel Estimation Method:

In the prior arts [B14] and [B15], blind channel estimation methods were proposed. Usually, the efficiency of the bandwidth usage is not reduced in this method; however, the BER performance is poor in a high vehicular speed environment. Additionally, in the prior art [B14], the performance of the method is very sensitive to the initial state of the channel, and in the prior art [B15], a higher-order statistical characteristic of signals is needed. Generally, the statistical characteristic is estimated by received signals that have been received for a long period of time, but in a high vehicular speed environment, estimation of the high-order statistical characteristic may become inaccurate so that the BER performance is poor.

In order to bring about an improvement in the drawbacks of the above-mentioned prior arts, it is the main objective of the present invention to propose a channel estimation and data detection method for wireless communication systems, and in particular a channel impulse response estimation method for STBC/OFDM systems as well as a method utilizing data subcarriers and sparse pilot subcarriers for tracking channel variations under a high vehicular speed and large channel delay spread environment so as to improve the accuracy of the channel estimation.

Another objective of the present invention is to base on an optimal joint channel estimation and data detection method and to utilize data subcarriers together with sparse pilot subcarriers so as to track channel variations under a high-speed moving environment.

A further objective of the present invention is that, under an environment with large channel delay spread, the present invention can also provide an excellent and efficient performance.

Still another objective of the present invention is to take advantage of sparse pilot subcarriers in an OFDM symbol to calculate a direction vector for the first recursive searching in order to make the channel estimation more accurate.

Another further objective of the present invention is to provide a channel estimation and data detection method, in which, if the sparse pilot subcarriers described above are not available, the channel estimation can also become much more accurate by using another recursive algorithm in accordance with the present invention.

### SUMMARY OF THE INVENTION

Because the present invention is appropriate for an OFDM system as well as a STBC/OFDM system, it is therefore convenient to introduce at first the form of pilot signals and the format of transmitted packets used in these two systems.

### 1. OFDM System:

An impulse response of a time-varying channel model for broadband transmission signals can be represented as follows:

$$h [ t , τ ] = {\sum }_{p = 0}^{P - 1} {a}_{p} ( t ) δ [ τ - {τ}_{p} ] \qquad ( 1 )$$

where P is the number of resolvable paths, τₚ is the amount of delay of the pth path, αₚ (t) is the channel gain of the pth path. The αₚ (t) described above is a Gaussian random process; hence, the amplitude of αₚ (t) is a Rayleigh distribution. Additionally, it is assumed that all of the paths are mutually uncorrelated, where the path gains can be generated by using the Jake's model. In the viewpoint of the frequency domain, frequency response of a channel can be represented as follows:

$$H [ t , k ] = {\sum }_{p = 0}^{P - 1} {a}_{p} ( t ) exp \{ - j 2 π k {τ}_{p} / K \} \qquad ( 2 )$$

where k is the subcarrier index.

Refer to FIG. 1a, which is an illustrating diagram for an OFDM system. Assume that Q={Q₀, . . . , Q_{|Q|-1}} and J={J₀, . . . , J_{|J|-1}} represent a data subcarrier set and a pilot subcarrier set, respectively. Furthermore, Q ∪ J={0, . . . , K−1}=Ω, where Ω is a total subcarrier set, K is the total number of subcarriers, and |□| denotes the number of elements in a set. As shown in FIG. 1a, in the ith time slot, |Q| QPSK data symbols X⁽ⁱ⁾[k], k ε Q, and |J| pilot symbols X⁽ⁱ⁾[k], k ε J are modulated onto subcarriers via an OFDM modulator 11 to produce time-domain signals and then a guard interval of length G×T is attached in front of each OFDM symbol, and then OFDM symbols are radiated via an antenna, in which T is useful symbol time, and G is a ratio of the guard interval to the useful symbol time. Further, referring to FIG. 1b, it is a schematic diagram of the packet format used in an OFDM system, in which a preamble 13 occupying one OFDM symbol is contained in each transmitted packet to serve as a pilot signal. The preamble 13 is followed immediately by D OFDM data symbols 14. The pilot signal defined in frequency domain is given as Xₚ[k], k ε Ω. Nevertheless, the design of the pilot signal does not limit to this example. Suppose that the timing and the carrier frequency are perfectly synchronized, the length of the channel impulse response is smaller than that of the guard interval, and the channel does not change within a single OFDM data symbol. Without loss of generality, index of time is omitted. As shown in FIG. 1a, after performing a Fourier transformation in the OFDM demodulator 12, the received data signals can be represented as follows:

R[k]=R^{I}[k]+jR^{Q}[k]=H[k]X[k]+Z[k] (3)

where k ε Ω, and Z [k] is an uncorrelated white Gaussian noise with zero-mean and variance σ²_{z}, (·)^{I} and (·)^{Q} denote the real and the imaginary parts of the signal (·), respectively. Similarly, after performing a Fourier transformation, the received pilot signals can be represented as follows:

R̅[k]= R̅^{I}[k]+j R̅^{Q}[k]=H[k]Xₚ[k]+Z[k] (4)

### 2. STBC/OFDM System:

A impulse response of a two-input-single-out (2ISO) and time-varying channel for broadband transmission signals can be represented in the equation (5) (the mth transmit antenna to the receiver end):

$${h}_{m} [ t , τ ] = {\sum }_{p = 0}^{P - 1} {a}_{m , p} ( t ) δ [ τ - {τ}_{m , p} ] \qquad ( 5 )$$

where m=1, 2, P is the number of resolvable paths, τ_{m,p} is the excess delay of the pth path, a_{m,p} (t) is the channel's complex gain of the pth path. The a_{m,p} (t) described above is a Gaussian random process; hence, the amplitude of a_{m,p} (t) is a Rayleigh distribution. In addition, suppose that all of the paths are mutually uncorrelated, and then the complex path gain can be generated by Jake's model. Therefore, in the viewpoint of frequency domain, the channel frequency response can be represented as follows:

$${H}_{m} [ t , k ] = {\sum }_{p = 0}^{P - 1} {a}_{m , p} ( t ) exp \{ - j 2 π k {τ}_{m , p} / K \} \qquad ( 6 )$$

where k is the index of subcarriers.

Refer to the diagram shown in FIG. 1c, which is a schematic diagram for a 2ISO STBC/OFDM system. Assume that Q={Q₀, . . . , Q_{|Q|-1}} and J={J₀, . . . , J_{|J|-1}} represent a data subcarrier set and a pilot subcarrier set, respectively. Furthermore, Q ∪ J={0, . . . , K−1}=Ω, where Ω is a total subcarrier set, K is the total number of subcarriers, and |·| denotes the number of elements in a set. In the ith time slot, 2|Q| QPSK data symbols d^{(j)}[k] (where k ε Q ∪ {K+Q}) and 2|J| pilot symbols d^{(j)}[k] (where k ε J ∪ {K+J}) are firstly divided into two data blocks as follows:

X_{F}⁽ⁱ⁾[k]=d⁽ⁱ⁾[k]

X_{S}⁽ⁱ⁾[k]=d⁽ⁱ⁾[k+K] (7)

where k ε Ω, X_{F}⁽ⁱ⁾[k] and X_{S}⁽ⁱ⁾[k] denote the kth data symbols of the first and the second data blocks, respectively. Subsequently, the present invention adopts the 2*2 STBC 1 proposed by Alamouti to encode the two data blocks as follows, where * denotes taking complex conjugate of a signal:

$$[ \begin{matrix}{X}_{F}^{( i )} [ k ] & {X}_{S}^{( i )} [ k ] \\ - {X}_{S}^{* ( i )} [ k ] & {X}_{F}^{* ( i )} [ k ]\end{matrix} ] \qquad ( 8 )$$

Finally, as shown in FIG. 1c, the STBC encoded signals of (8) are modulated separately onto subcarriers via two OFDM modulators 2 to produce time-domain signals, where a guard interval of length G·T is attached in front of each OFDM symbol, and then OFDM symbols are radiated via two corresponding antennas, in which T is useful symbol time and G is a ratio of the guard interval time to the useful symbol time.

Next, refer to FIG. 1d, which is an illustrative diagram for the packet format used in STBC/OFDM systems, in which each transmitted packet contains a pilot signal having a length of two OFDM symbols followed by D OFDM data symbols 5. The present invention, to serve as an illustrating example, takes a pair of complementing codes {A[n]} and {B[k]} with length K to act as a preamble 4. However, the design of a preamble does not limit to the present example. The complementary-coded preamble can be transmitted in the following way (referring to the prior art [B8]): In the first symbol time, the signals {A[n]} and {−B[k]} are transmitted via the first and the second antennas, respectively; in the second symbol time, the signals {B*[((−n))_{K}]} and {A*[((−n))_{K}]} are transmitted via the first and the second antennas respectively. Suppose that the timing and the carrier frequency are perfectly synchronized, the length of the channel impulse response is smaller than that of the guard interval, and the channel does not change within two OFDM data symbols. Without loss of generality, index of time is omitted. As shown in FIG. 1c, after performing a Fourier transformation in the OFDM demodulator 12, the received data signals in a time slot, containing two OFDM symbols, can be represented as follows:

R₁[k]=R₁^{I}[k]+jR₁^{Q}[k]=H₁[k]X_{F}[k]+H₂[k]X_{S}[k]+Z₁[k]

R₂[k]=R₂^{I}[k]+jR₂^{Q}[k]=−H₁[k]X_{S}*[k]+H₂[k]X_{F}*[k]+Z₂[k] (9)

where k ε Ω, Z₁[k] and Z₂[k] are uncorrelated white Gaussian noises with zero-mean and variance σ_{Z}².

The proposed channel estimator with respect to the channel frequency response Hₘ[k] is Mₘ[k], and the Mₘ[k] is composed of Lₘ complex sinusoidal waves, which can be represented as follows:

$$\begin{matrix}{M}_{m} [ k ] = {M}_{m}^{I} [ k ] + j {M}_{m}^{Q} [ k ] \\ = {\sum }_{l = 0}^{{L}_{m} - 1} {μ}_{m , l} exp \{ - j 2 π k {τ}_{m , l} / K \} \\ = {\sum }_{l = 0}^{{L}_{m} - 1} ( {α}_{m , l} cos ( \frac{2 π k {τ}_{m , l}}{K} ) + {β}_{m , l} sin ( \frac{2 π k {τ}_{m , l}}{K} ) ) + \\ j {\sum }_{l = 0}^{{L}_{m} - 1} ( {β}_{m , l} cos ( \frac{2 π k {τ}_{m , l}}{K} ) - {α}_{m , l} sin ( \frac{2 π k {τ}_{m , l}}{K} ) )\end{matrix} \qquad ( 10 )$$

where μ_{m,l}=α_{m,l}+jβ_{m,l} and τ_{m,l} are the complex gain and the excess delay, respectively, of the lth path of the mth channel. Without loss of generality, suppose that the channel delay can be estimated by pilot signals, and the channel delay does not change during each packet transmission. According to Equations (9) and (10), the joint channel estimation and data detection can be presented in a maximum likelihood estimation problem as follows:

$$〈 {\hat{X}}_{F} , {\hat{X}}_{S} , {\hat{M}}_{1} , {\hat{M}}_{2} 〉 = arg {min}_{〈 {X}_{F} , {X}_{S} , {M}_{1} , {M}_{2} 〉} {\sum }_{k ∈ Θ} \{ \begin{matrix}{\vert {R}_{1} [ k ] - {M}_{1} [ k ] {X}_{F} [ k ] - {M}_{2} [ k ] {X}_{S} [ k ] \vert}^{2} + \\ {\vert {R}_{2} [ k ] + {M}_{1} [ k ] {X}_{S}^{*} [ k ] - {M}_{2} [ k ] {X}_{F}^{*} [ k ] \vert}^{2}\end{matrix} \} \qquad ( 11 )$$

where Θ={Θ₀, . . . , Θ_{|Θ|-1}} is a set of data subcarriers to be used for tracking the channel variation, which is a subset of Q. Therefore Equation (11) can be rewritten as follows:

$$〈 {\hat{X}}_{F} , {\hat{X}}_{S} , {\hat{M}}_{1} , {\hat{M}}_{2} 〉 = arg {min}_{〈 {M}_{1} , {M}_{2} 〉} {min}_{〈 {X}_{F} , {X}_{S} 〉} {\sum }_{k ∈ Θ} \{ \begin{matrix}{\vert {R}_{1} [ k ] - {M}_{1} [ k ] {X}_{F} [ k ] - {M}_{2} [ k ] {X}_{S} [ k ] \vert}^{2} + \\ {\vert {R}_{2} [ k ] + {M}_{1} [ k ] {X}_{S}^{*} [ k ] - {M}_{2} [ k ] {X}_{F}^{*} [ k ] \vert}^{2}\end{matrix} \} \qquad ( 12 )$$

Hence, in the present invention, according to Alamouti's decoding algorithm, Equation (12) can be rewritten as follows:

$$〈 {\hat{M}}_{1} , {\hat{M}}_{2} 〉 = arg {min}_{〈 {M}_{1} , {M}_{2} 〉} {\sum }_{k ∈ Θ} \{ \begin{matrix}{\vert {R}_{1} [ k ] - {M}_{1} [ k ] Φ ( {χ}_{F} [ k ] ) - {M}_{2} [ k ] Φ ( {χ}_{S} [ k ] ) \vert}^{2} + \\ {\vert {R}_{2} [ k ] + {M}_{1} [ k ] {Φ}^{*} ( {χ}_{S} [ k ] ) - {M}_{2} [ k ] {Φ}^{*} ( {χ}_{F} [ k ] ) \vert}^{2}\end{matrix} \} \qquad ( 13 )$$

where χ_{F}[k] and χ_{S}[k] are the decision statistics corresponding to X_{F}[k] and X_{S}[k], respectively. χ_{F}[k] and χ_{S}[k] can be represented as follows:

χ_{F}[k]=χ_{F}^{I}[k]+jχ_{F}^{Q}[k]=M₁*[k]R₁[k]+M₂[k]R₂*[k]

χ_{S}[k]=χ_{S}^{I}[k]+jχ_{S}^{Q}[k]=M₂*[k]R₁[k]−M₁[k]R₂*[k] (14)

The function Φ (□) is a common binary detector: Suppose η is a real number, then if, η≧0, Φ(η)=+1, and if, η<0, Φ(η)=−1; suppose η is a complex number, then its real and imaginary parts can be detected separately. Finally, in Equation (14), separate the real part from the imaginary part to obtain a new cost function as follows:

$$\hat{y} = arg {min}_{y} f ( y ) \qquad ( 15 )$$

where f(y)=Σ_{kεΘ}Σᵤ₌₀³Ψ_{u,k}²(y), in which

y= [symbol] α_{1,0}, . . . , α_{1,(L}_{₁}₋₁₎, α_{2,0} . . . , α_{2,(L}_{₂}₋₁₎, β_{1,0}, . . . , β_{1,(L}_{₁}₋₁₎, β_{2,0} . . . , β_{2(L}_{₂}₋₁₎

[symbol]

is the vector of the channel state information, and

Ψ_{0.k}(y)=R₁^{I}[k]−M₁^{I}[k]Φ(χ_{F}^{I}[k])+M₁^{Q}[k]Φ(χ_{F}^{Q}[k])−M₂^{I}[k]Φ(χ_{S}^{I}[k])+M₂^{Q}[k]Φ(χ_{S}^{Q}[k]);

Ψ_{1.k}(y)=R₁^{Q}[k]−M₁^{I}[k]Φ(χ_{F}^{Q}[k])−M₁^{Q}[k]Φ(χ_{F}^{I}[k])−M₂^{I}[k]Φ(χ_{S}^{Q}[k])−M₂^{Q}[k]Φ(χ_{S}^{I}[k]);

Ψ_{2.k}(y)=R₂^{I}[k]+M₁^{I}[k]Φ(χ_{S}^{I}[k])+M₁^{Q}[k]Φ(χ_{S}^{Q}[k])−M₂^{I}[k]Φ(χ_{F}^{I}[k])−M₂^{Q}[k]Φ(χ_{F}^{Q}[k]);

Ψ_{3.k}(y)=R₂^{Q}[k]−M₁^{I}[k]Φ(χ_{S}^{Q}[k])+M₁^{Q}[k]Φ(χ_{S}^{I}[k])+M₂^{I}[k]Φ(χ_{F}^{Q}[k])−M₂^{Q}[k]Φ(χ_{F}^{I}[k]).

The present invention utilizes Newton's method to search for the extreme point of Equation (15), and therefore a recursive formula for a semi-blind channel estimation method can be represented by the following equation:

y^{(i,v)}=y^{(i,v-1)}−g^{(i,v)} (16)

where g^{(i,v)} is a searching direction vector which can be represented as g^{(i,v)}=(F(y^{(i,v-1)})+λI_{2(L}_{₁}_{+L}_{₂}₎)⁻¹∇f(y^{(i,v-1)}) , v is the index for recursion and v=1, . . . , V, V is the maximum number of recursion, λ is a constant with λ≧0, I_{N} is an N×N identity matrix, F(y) and ∇f(y) are respectively the Hessian matrix and the gradient vector of f(y). Hence, the gradient vector can be derived as follows:

$${( ∇ f ( y ) )}_{j} = \frac{\partial f ( y )}{\partial {y}_{j}} = 2 {\sum }_{k ∈ Θ} {\sum }_{u = 0}^{3} \frac{\partial {ψ}_{u , k} ( y )}{\partial {y}_{j}} {ψ}_{u , k} ( y ) \qquad ( 17 )$$

Suppose the probability of χ_{F}[k]=0 (or χ_{S}[k]=0) is zero, and therefore the partial derivative ∂Ψ_{u,k} (y)/∂y₁, 0≦l≦L₁−1, can be computed as follows:

$$\begin{matrix}\frac{\partial {ψ}_{0 , k} ( y )}{\partial {y}_{l}} = \frac{\partial {ψ}_{0 , k} ( y )}{\partial {α}_{1 , l}} & ( 18 ) \\ = - cos ( \frac{2 π k {τ}_{1 , l}}{K} ) Φ ( {χ}_{F}^{I} [ k ] ) - sin ( \frac{2 π k {τ}_{1 , l}}{K} ) Φ ( {χ}_{F}^{Q} [ k ] ) & \\ \frac{\partial {ψ}_{1 , k} ( y )}{\partial {y}_{l}} = \frac{\partial {ψ}_{1 , k} ( y )}{\partial {α}_{1 , l}} & ( 19 ) \\ = - cos ( \frac{2 π k {τ}_{1 , l}}{K} ) Φ ( {χ}_{F}^{Q} [ k ] ) + sin ( \frac{2 π k {τ}_{1 , l}}{K} ) Φ ( {χ}_{F}^{I} [ k ] ) & \\ \frac{\partial {ψ}_{2 , k} ( y )}{\partial {y}_{l}} = \frac{\partial {ψ}_{2 , k} ( y )}{\partial {α}_{1 , l}} & ( 20 ) \\ = cos ( \frac{2 π k {τ}_{1 , l}}{K} ) Φ ( {χ}_{S}^{I} [ k ] ) - sin ( \frac{2 π k {τ}_{1 , l}}{K} ) Φ ( {χ}_{S}^{Q} [ k ] ) & \\ \frac{\partial {ψ}_{3 , k} ( y )}{\partial {y}_{l}} = \frac{\partial {ψ}_{3 , k} ( y )}{\partial {α}_{1 , l}} & ( 21 ) \\ = - cos ( \frac{2 π k {τ}_{1 , l}}{K} ) Φ ( {χ}_{S}^{Q} [ k ] ) - sin ( \frac{2 π k {τ}_{1 , l}}{K} ) Φ ( {χ}_{S}^{I} [ k ] ) & \end{matrix}$$

where the partial derivative ∂Ψ_{u,k} (y)/∂y_{L}_{₁}₊ₗ, 0≦l≦L₂−1, can be computed as follows:

$$\begin{matrix}\frac{\partial {ψ}_{0 , k} ( y )}{\partial {y}_{{L}_{1} + l}} = \frac{\partial {ψ}_{0 , k} ( y )}{\partial {α}_{2 , l}} & ( 22 ) \\ = - cos ( \frac{2 π k {τ}_{2 , l}}{K} ) Φ ( {χ}_{S}^{I} [ k ] ) - sin ( \frac{2 π k {τ}_{2 , l}}{K} ) Φ ( {χ}_{F}^{Q} [ k ] ) & \\ \frac{\partial {ψ}_{1 , k} ( y )}{\partial {y}_{{L}_{1} + l}} = \frac{\partial {ψ}_{1 , k} ( y ) }{\partial {α}_{2 , l}} & ( 23 ) \\ = - cos ( \frac{2 π k {τ}_{2 , l}}{K} ) Φ ( {χ}_{S}^{Q} [ k ] ) + sin ( \frac{2 π k {τ}_{2 , l}}{K} ) Φ ( {χ}_{S}^{I} [ k ] ) & \\ \frac{\partial {ψ}_{2 , k} ( y )}{\partial {y}_{{L}_{1} + l}} = \frac{\partial {ψ}_{2 , k} ( y ) }{\partial {α}_{2 , l}} & ( 24 ) \\ = - cos ( \frac{2 π k {τ}_{2 , l}}{K} ) Φ ( {χ}_{F}^{I} [ k ] ) + sin ( \frac{2 π k {τ}_{2 , l}}{K} ) Φ ( {χ}_{F}^{Q} [ k ] ) & \\ \frac{\partial {ψ}_{3 , k} ( y )}{\partial {y}_{{L}_{1} + l}} = \frac{\partial {ψ}_{3 , k} ( y ) }{\partial {α}_{2 , l}} & ( 25 ) \\ = cos ( \frac{2 π k {τ}_{2 , l}}{K} ) Φ ( {χ}_{F}^{Q} [ k ] ) + sin ( \frac{2 π k {τ}_{2 , l}}{K} ) Φ ( {χ}_{F}^{I} [ k ] ) & \end{matrix}$$

where the partial derivative ∂Ψ_{u,k} (y)/∂y_{L}_{₁}_{+L}_{₂}₊ₗ, 0≦l≦L₁−1, can be computed as follows:

$$\begin{matrix}\frac{\partial {ψ}_{0 , k} ( y )}{\partial {y}_{{L}_{1} + {L}_{2} + l}} = \frac{\partial {ψ}_{0 , k} ( y ) }{\partial {β}_{1 , l}} & ( 26 ) \\ = - sin ( \frac{2 π k {τ}_{1 , l}}{K} ) Φ ( {χ}_{F}^{I} [ k ] ) + cos ( \frac{2 π k {τ}_{1 , l}}{K} ) Φ ( {χ}_{F}^{Q} [ k ] ) & \\ \frac{\partial {ψ}_{1 , k} ( y )}{\partial {y}_{{L}_{1} + {L}_{2} + l}} = \frac{\partial {ψ}_{1 , k} ( y ) }{\partial {β}_{1 , l}} & ( 27 ) \\ = - sin ( \frac{2 π k {τ}_{1 , l}}{K} ) Φ ( {χ}_{F}^{Q} [ k ] ) - cos ( \frac{2 π k {τ}_{1 , l}}{K} ) Φ ( {χ}_{F}^{I} [ k ] ) & \\ \frac{\partial {ψ}_{2 , k} ( y )}{\partial {y}_{{L}_{1} + {L}_{2} + l}} = \frac{\partial {ψ}_{2 , k} ( y ) }{\partial {β}_{1 , l}} & ( 28 ) \\ = sin ( \frac{2 π k {τ}_{1 , l}}{K} ) Φ ( {χ}_{S}^{I} [ k ] ) + cos ( \frac{2 π k {τ}_{1 , l}}{K} ) Φ ( {χ}_{S}^{Q} [ k ] ) & \\ \frac{\partial {ψ}_{3 , k} ( y )}{\partial {y}_{{L}_{1} + {L}_{2} + l}} = \frac{\partial {ψ}_{3 , k} ( y ) }{\partial {β}_{1 , l}} & ( 29 ) \\ = - sin ( \frac{2 π k {τ}_{1 , l}}{K} ) Φ ( {χ}_{S}^{Q} [ k ] ) + cos ( \frac{2 π k {τ}_{1 , l}}{K} ) Φ ( {χ}_{S}^{I} [ k ] ) & \end{matrix}$$

where the partial derivative ∂Ψ_{u,k} (y)/∂y_{2L}_{₁}_{+L}_{₂}₊ₗ, 0≦l≦L₂−1, can be computed as follows:

$$\begin{matrix}\frac{\partial {ψ}_{0 , k} ( y )}{\partial {y}_{2 {L}_{1} + {L}_{2} + l}} = \frac{\partial {ψ}_{0 , k} ( y ) }{\partial {β}_{2 , l}} & ( 30 ) \\ = - sin ( \frac{2 π k {τ}_{2 , l}}{K} ) Φ ( {χ}_{S}^{I} [ k ] ) + cos ( \frac{2 π k {τ}_{2 , l}}{K} ) Φ ( {χ}_{S}^{Q} [ k ] ) & \\ \frac{\partial {ψ}_{1 , k} ( y )}{\partial {y}_{2 {L}_{1} + {L}_{2} + l}} = \frac{\partial {ψ}_{1 , k} ( y ) }{\partial {β}_{2 , l}} & ( 31 ) \\ = - sin ( \frac{2 π k {τ}_{2 , l}}{K} ) Φ ( {χ}_{S}^{Q} [ k ] ) - cos ( \frac{2 π k {τ}_{2 , l}}{K} ) Φ ( {χ}_{S}^{I} [ k ] ) & \\ \frac{\partial {ψ}_{2 , k} ( y )}{\partial {y}_{2 {L}_{1} + {L}_{2} + l}} = \frac{\partial {ψ}_{2 , k} ( y ) }{\partial {β}_{2 , l}} & ( 32 ) \\ = - sin ( \frac{2 π k {τ}_{2 , l}}{K} ) Φ ( {χ}_{F}^{I} [ k ] ) - cos ( \frac{2 π k {τ}_{2 , l}}{K} ) Φ ( {χ}_{F}^{Q} [ k ] ) & \\ \frac{\partial {ψ}_{3 , k} ( y )}{\partial {y}_{2 {L}_{1} + {L}_{2} + l}} = \frac{\partial {ψ}_{3 , k} ( y ) }{\partial {β}_{2 , l}} & ( 33 ) \\ = sin ( \frac{2 π k {τ}_{2 , l}}{K} ) Φ ( {χ}_{F}^{Q} [ k ] ) - cos ( \frac{2 π k {τ}_{2 , l}}{K} ) Φ ( {χ}_{F}^{I} [ k ] ) & \end{matrix}$$

Additionally, the Hessian matrix can be computed as follows:

$$\begin{matrix}{( F ( y ) )}_{i , j} = {( F )}_{i , j} \\ = \frac{{\partial }^{2} f ( y )}{\partial {y}_{i} \partial {y}_{j}} \\ = 2 {\sum }_{k ∈ Θ} {\sum }_{u = 0}^{3} ( \frac{\partial {ψ}_{u , k} ( y )}{\partial {y}_{i}} \frac{\partial {ψ}_{u , k} ( y )}{\partial {y}_{j}} + {ψ}_{u , k} ( y ) \frac{{\partial }^{2} {ψ}_{u , k} ( y )}{\partial {y}_{i} \partial {y}_{j}} ) \\ \approx 2 {\sum }_{k ∈ Θ} {\sum }_{u = 0}^{3} \frac{\partial {ψ}_{u , k} ( y )}{\partial {y}_{i}} \frac{\partial {ψ}_{u , k} ( y )}{\partial {y}_{j}} \\ = \{ \begin{matrix}8 {\sum }_{k ∈ Θ} cos ( 2 π k ( {τ}_{a ( i ) , b ( i )} - {τ}_{a ( j ) , b ( j )} ) / K ) , \\ for ( κ + {κ}^{′} ) {L}_{1} + κ {L}_{2} \leq i , j \leq ( κ + 1 ) {L}_{1} + ( κ + {κ}^{′} ) {L}_{2} - 1 , \\ where κ , {κ}^{′} = 0 or 1 \\ 0 , otherwise\end{matrix}\end{matrix} \qquad ( 34 )$$

where a(i)=U(((i))_{L}_{₁}_{+L}_{₂}−L₁)+1, b(i)=((i))_{L}_{₁}_{+L}_{₂}−(a(i)−1) L₁, U (□) is a Heaviside unit step function, ((□))_{N} denotes the modulo-N arithmetic operation.

Refer to the schematic diagram shown in FIG. 2, which is a recursive algorithm for the semi-blind channel estimation method proposed in the present invention. The algorithm is divided into six steps and will hereafter be described in more detail:

Step 1 (Preliminary Step 21): After passing the received signals through an OFDM demodulator, frequency-domain signals R̅₁[k] and R̅₂[k] of the complementary-coded pilot preambles in two successive OFDM symbol times, as well as two successive OFDM data symbols R₁⁽ⁱ⁾[k] and R₂⁽ⁱ⁾[k] at the ith time slot, can be obtained.

Step 2: In the initial phase, set up the predetermined number Nₚ of the channel paths in a mobile wireless environment; use the complementary-coded pilot preambles to estimate the channel impulse response, and then use this estimation result of the channel impulse response to calculate a path selective set Sₘ.

Step 3: In accordance with the path selective set Sₘ, the number Lₘ of the selected paths and the delay τ_{m,l} of the selected path are determined, and then the initial channel state information vector y^{(1,0)} and the Hessian matrix F are calculated. The Initial Step 22 of the present invention comprises Step 2 and Step 3.

Step 4: In the tracking phase, the initial value v of the recursion index is set to 1 at first, and the maximum number of recursion is set to V.

Step 5: Calculate the searching direction vector g^{(i,v)}=(F+λI_{2(L}_{₁}_{+L}_{₂}₎)⁻¹∇f(y^{(i,v-1)}) and update the channel state information vector by y^{(i,v)}=y^{(i,v-1)}−g^{(i,v)}. Increase the index of recursion by 1. If the index v of recursion is less than or equal to V, repeat Step 5.

Step 6: Take the channel state information estimated at this time slot to be the initial value of the channel state information at the next time slot, i.e. y^{(i+1,0)}=y^{(i,V)}. The Tracking Step 23 of the present invention comprises Step 4 to Step 6.

In the initial phase, a common channel impulse response estimation method can be used to determine the parameters Lₘ and τ_{m,l} as well as the initial channel estimation for equation (16). In the present invention, for example, complementary-coded pilot preambles are used to initialize the channel estimation, which can be expressed as follows: (There is provided only a feasible example, but the channel initialization method of the present invention does not limit only to this method.)

h̅₁[n]=IDFT{P_{A}*[k] R̅₁[k]+P_{B}[k] R̅₂[k]}

h̅₂[n]=IDFT{−P_{B}*[k] R̅₁[k]+P_{A}[k] R̅₂[k]} (35)

where R̅₁[k] and R̅₂[k] are complementary-coded pilot preambles received in two successive OFDM symbol times, IDFT {□} is a K-point inverse discrete Fourier transform, P_{A}[k] and P_{A}[k] are the frequency-domain signals of the complementary signals {A[n]} and {B[n]}, respectively. Next, in the present invention, there is defined a path selective set Sₘ={n: for n ε Ω, and | h̅ₘ[n]| is one of the Np larger value} ∩ {0, . . . (G·K)−1}, where Nₚ is a predetermined number of possible paths, the parameter Lₘ is the number of selected paths, which is the number of elements in the set Sₘ, and τ_{m,l} is the excess delay of the selected path, which is the value of an element in Sₘ. The initial value of the channel is, y^{(1,0)}= [symbol] ρ_{1,I},ρ_{2,I},ρ_{1,Q},ρ_{2,Q} [symbol] , where ρ_{1,I}= [symbol] h̅₁^{I}[n]:n ε S₁ [symbol] , ρ_{2,I}= [symbol] h̅₂^{I}[n]:n ε S₂ [symbol] , ρ_{1,Q}= [symbol] h̅₁^{Q}[n]:n ε S₁ [symbol] , and ρ_{2,Q}= [symbol] h̅₂^{Q}[n]:n ε S₂ [symbol] .

In the tracking phase, for each time slot, it is possible to continuously execute Equation (16) in order to obtain new channel estimation. Finally, the channel estimation of the present time slot can be taken to be the initial value of the channel estimation at the next time slot, namely y^{(i+1,0)}=y^{(i,V)}.

The performance of the semi-blind channel estimation method described above may degrade as the length of the transmitted packet becomes larger, especially in a fast time-varying channel. Therefore, another preferred channel estimation method of the present invention is a robust semi-blind channel estimation method which is a further refinement of the semi-blind channel estimation method. As shown in FIG. 3, in this method, sparse pilot subcarriers inside an OFDM symbol are used to calculate the searching direction vector at the first recursion so that the channel estimation is much more accurate. Hereafter, the steps of the recursive algorithm will be described in more detail in the following:

Step 1 (Preliminary Step 31): After passing the received signal through an OFDM demodulator, frequency-domain signals R̅₁[k] and R̅₂[k] of the complementary-coded pilot preambles in two successive OFDM symbol times, as well as two successive OFDM data symbols R₁⁽ⁱ⁾[k] and R₂⁽ⁱ⁾[k] at the ith time slot, can be obtained.

Step 2: In the initial phase, set up the predetermined number Nₚ of the channel paths in a mobile wireless environment; use complementary-coded pilot preambles to estimate the channel impulse responses, and then use this estimation result of the channel impulse response to calculate a path selective set Sₘ.

Step 3: In accordance with the path selective set Sₘ, the number Lₘ of the selected paths and the excess delay τ_{m,l} of the selected path are determined, and then the initial channel state information vector y^{(1,0)} and the Hessian matrix F are calculated.

The Initial Step 32 of the present invention comprises Step 2 and Step 3.

Step 4: In the tracking phase, the initial value v of the recursion index is set to 1 at first, and the maximum number of recursion is set to V.

Step 5: If the index v of recursion is 1, use sparse pilot subcarriers to calculate channel state information Ĥₘ[k], and then calculate a searching direction vector Ψ that is obtained by using the sparse pilot subcarriers; then use Equation (39) to calculate a searching direction vector g^{(i,1)}=μyΨ⁽ⁱ⁾+(1−μ)(F+λI_{2(L}_{₁}_{+L}_{₂}₎)⁻¹∇f(y^{(i,0)}). If the index of recursion is not equal to 1, calculate the searching direction vector as g^{(i,v)}=(F+λI_{2(L}_{₁}_{+L}_{₂}₎)⁻¹∇f(y^{(i,v-1)}).

Step 6: Update the channel state information vector by y^{(i,v)}=y^{(i,v-1)}−g^{(i,v)}, and increase the index of recursion by 1. If the index v of recursion is less than or equal to V, repeat Step 5.

Step 7: Take the channel state information estimated at this time slot to be the initial value of the channel state information at the next time slot, i.e. y^{(i+1,0)}=y^{(i,V)}. The Tracking Step 33 of the present invention comprises Step 4 to Step 7.

In the ith time slot, the present invention uses pilot subcarriers to estimate the frequency response Ĥₘ[k],k ε J of the mth channel as follows:

Ĥ₁[k]=(X_{F}[k]R₁[k]−X_{S}[k]R₂[k])/(X_{F}²[k]+X_{S}²[k])

Ĥ₂[k]=(X_{S}[k]R₁[k]+X_{F}[k]R₂[k])/(X^{F}²[k]+X_{S}²[k]) (36)

By using Equation (10) and Equation (36), a maximum likelihood function \hat{f}ₘ(α_{m,0}, . . . α_{m,L}_{ₘ}₋₁, β_{m,0}, β_{m,L}_{ₘ}₋₁) can be defined as follows:

$${\hat{f}}_{m} ( {α}_{m , 0} , ⋯ {α}_{m , {L}_{m} - 1} , {β}_{m , 0} , {β}_{m , {L}_{m} - 1} ) = {\sum }_{k ∈ J} ( \begin{matrix}{( {\sum }_{l = 0}^{{L}_{m} - 1} ( {α}_{m , l} cos ( \frac{2 π k {τ}_{m , l}}{K} ) + {β}_{m , l} sin ( \frac{2 π k {τ}_{m , l}}{K} ) ) - ℜ e \{ {{H}^{⋒}}_{m} [ k ] \} )}^{2} + \\ {( {\sum }_{l = 0}^{{L}_{m} - 1} ( {β}_{m , l} cos ( \frac{2 π k {τ}_{m , l}}{K} ) - {α}_{m , l} sin ( \frac{2 π k {τ}_{m , l}}{K} ) ) - m \{ {{H}^{⋒}}_{m} [ k ] \} )}^{2}\end{matrix} ) \qquad ( 37 )$$

Therefore, for the partial derivative of the function \hat{f}ₘ(α_{m,0}, . . . α_{m,L}_{ₘ}₋₁, β_{m,0}, β_{m,L}_{ₘ}₋₁), its value at y=y^{(i-1,v)} can be computed as follows:

$${ζ}_{m} = 2 \cdot [ \begin{matrix}{e}^{\frac{j 2 π {J}_{0} {τ}_{m , 0}}{K}} & ⋯ & {e}^{\frac{j 2 π {J}_{\vert J \vert - 1} {τ}_{m , 0}}{K}} \\ ⋮ & ⋰ & ⋮ \\ {e}^{\frac{j 2 π {J}_{0} {τ}_{m , {L}_{m} - 1}}{K}} & ⋯ & {e}^{\frac{j 2 π {J}_{\vert J \vert - 1} {τ}_{m , {L}_{m} - 1}}{K}}\end{matrix} ] {Γ}_{m} \qquad ( 38 )$$

where ζₘ=((∂\hat{f}ₘ/∂α_{m,0}+j∂\hat{f}ₘ/∂β_{m,0}), . . . , (∂\hat{f}ₘ/∂α_{m,L}_{ₘ}₋₁+j∂\hat{f}ₘ/∂β_{m,L}_{ₘ}₋₁)), Γₘ=Mₘ⁽ⁱ⁻¹⁾−Ĥₘ, Ĥₘ=(Ĥₘ[k]:k ε J), and Mₘ⁽ⁱ⁻¹⁾=(Mₘ⁽ⁱ⁻¹⁾[k]:k ε J) , which is the channel estimation of the last recursion at the (i−1)th time slot. From Equation (38), a searching direction vector Ψ= [symbol] ζ₁^{I}, ζ₂^{I}, ζ₁^{Q}, ζ₂^{Q} [symbol] derived by using sparse pilot subcarriers can be obtained.

The difference between the recursive algorithm of the robust semi-blind channel estimation method proposed in the present invention and the recursive algorithm of the semi-blind channel estimation method lies in that the searching direction at the first recursion (at ith time slot) is modified as follows:

g^{(i,1)}=μγΨ⁽ⁱ⁾+(1−μ)(F+λI_{2(L}_{₁}_{+L}_{₂}₎)⁻¹∇f(y^{(i,0)}) (39)

where γ=ε∥(F+λI_{2(L}_{₁}_{+L}_{₂}₎)⁻¹∇f(y^{i,0})∥/∥Ψ⁽ⁱ⁾∥is a step size, and μ is a weighting factor with 0≦μ≦1. The step size γ is able to render the norm of the searching direction γΨ⁽ⁱ⁾ equal to ∥(F+λI_{2(L}_{₁}_{+L}_{₂}₎)⁻¹∇f(y^{(i,0)})∥, and furthermore a tuning factor ε can be used to adjust the size of γΨ⁽ⁱ⁾. Therefore, the searching direction γΨ⁽ⁱ⁾ provided in the robust semi-blind channel estimation method of the present invention is capable of making the said method converge toward the correct direction, especially in a high vehicular speed environment.

### BRIEF DESCRIPTION OF THE DRAWINGS

For the purpose that the said and other objectives, characteristics, and advantages of the present invention can be clearly seen, and be easily and obviously understood, preferred embodiments of the present invention are subsequently described by referring to the enclosing drawings, wherein:

FIG. 1a shows an OFDM system.

FIG. 1b shows a format of a packet transmitted by an OFDM system.

FIG. 1c shows an STBC/OFDM system.

FIG. 1d shows a format of a packet transmitted by an STBC/OFDM system.

FIG. 2 shows a recursive algorithm for a semi-blind channel estimation method.

FIG. 3 shows a recursive algorithm for a robust semi-blind channel estimation method.

FIG. 4 shows the bit error rate (BER) of the semi-blind channel estimation and the robust semi-blind channel estimation in a two-path fading channel with a vehicular speed of 120 km/hr.

FIG. 5 shows the bit error rate (BER) of the semi-blind channel estimation and the robust semi-blind channel estimation in a Veh.-B six-path fading channel with a vehicular speed of 120 km/hr.

FIG. 6 shows the bit error rate (BER) of the semi-blind channel estimation and the robust semi-blind channel estimation in a two-path fading channel with a vehicular speed of 240 km/hr.

FIG. 7 shows the bit error rate (BER) of the semi-blind channel estimation and the robust semi-blind channel estimation in a Veh.-B six-path fading channel with a vehicular speed of 240 km/hr.

FIG. 8 shows a list of the relevant parameters used in the system simulation of the present invention.

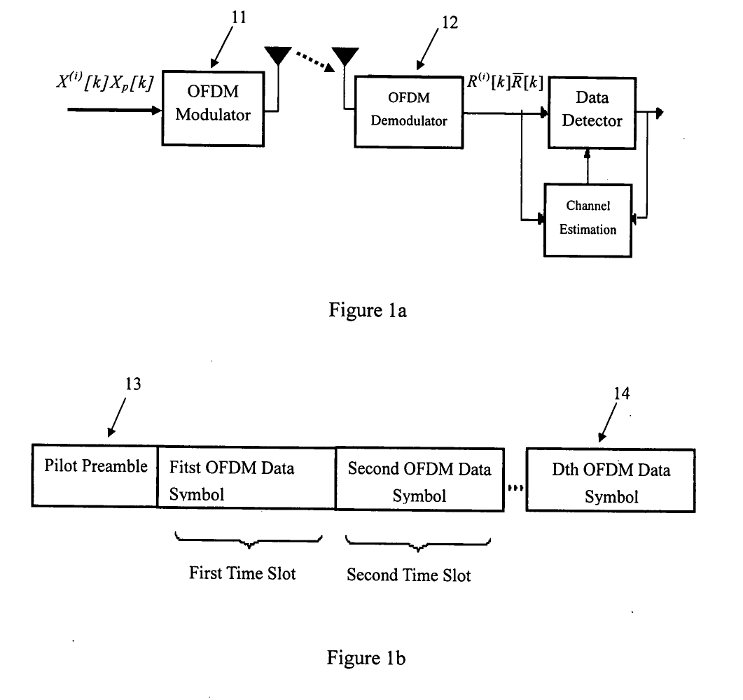

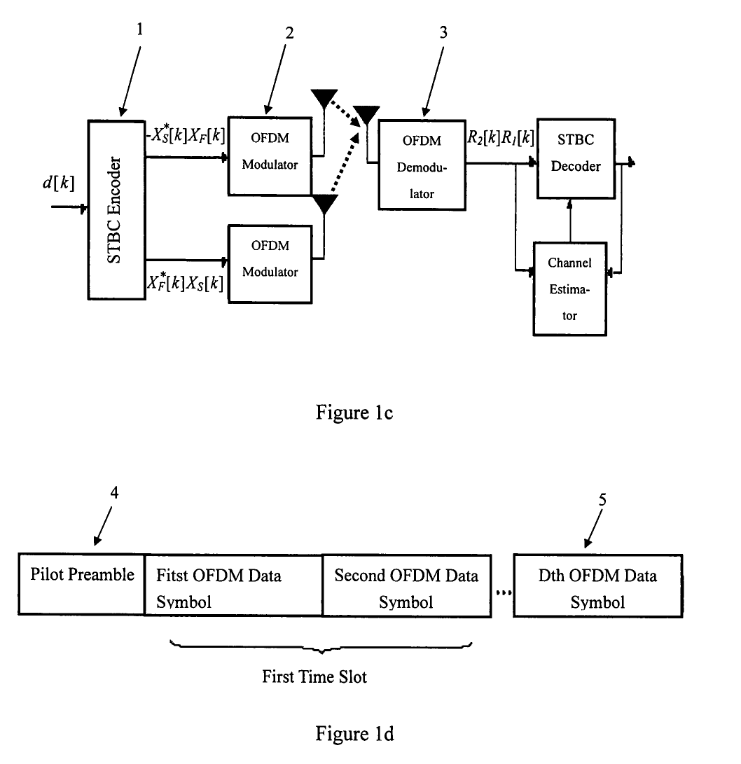

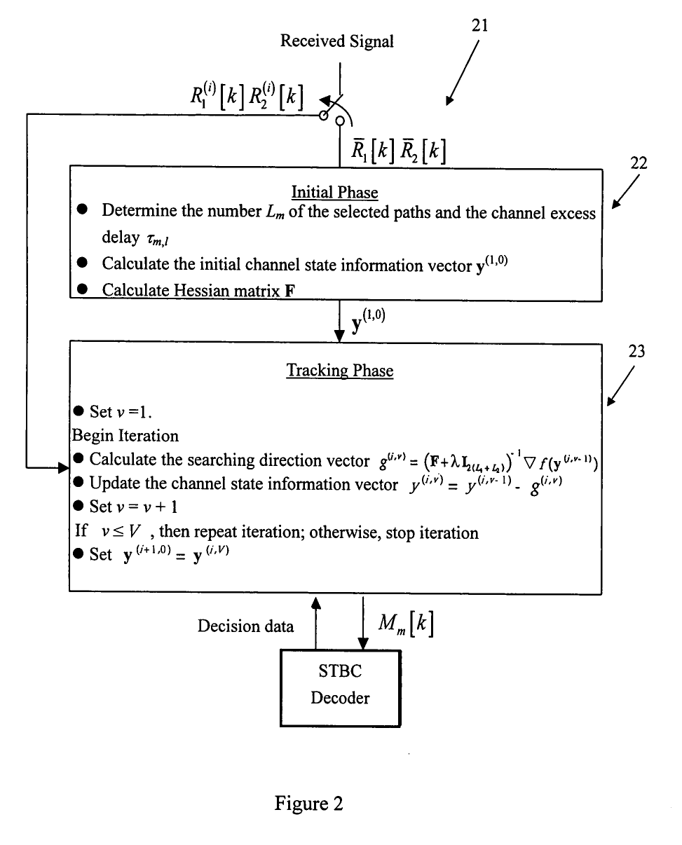

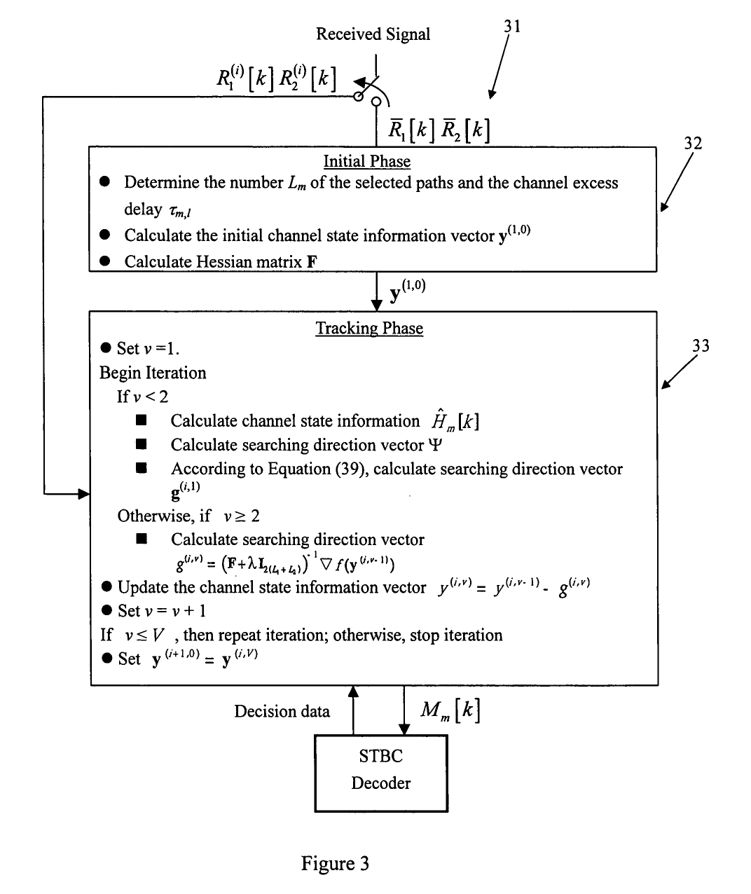

### DETAILED DESCRIPTION OF THE PREFERRED EMBODIMENTS

Here the present invention adopts two kinds of channel environments which are simulated by a computer to validate the inventive channel estimation method, where the two environments are respectively a two-path fading channel and a Veh.-B six-path fading channel defined by International Telecommunication Union (ITU); in addition, the simulation is performed in the two conditions that the speeds of a vehicle are 120 km/hr and 240 km/hr, respectively, so that the improvement of accuracy of the channel estimation of the present invention in an environment with a high vehicular speed and a large channel delay spread can be clearly seen as compared with prior arts.

For the two-path fading channel, energy profile of the paths is: 0,0 (dB), and the conditions for simulation are: the predetermined possible number of paths Nₚ=2, number of OFDM data symbols contained in a packet D=800, the parameter λ=10, maximum number of recursion V=5, tuning factor ε=2, and weighting factor μ=1. In addition, for the Veh.-B six-path fading channel, energy profile of the paths is: −2.5, 0, −12.8, −10, −25.2, −16 (dB), and the conditions for simulation are: the predetermined possible number of paths Nₚ=6, number of OFDM data symbols contained in a packet D=800, the parameter λ=10, maximum number of recursion V=5, tuning factor ε=2, and weighting factor μ=1. The set of data subcarriers, Θ, used for tracking the channel variation is set to be

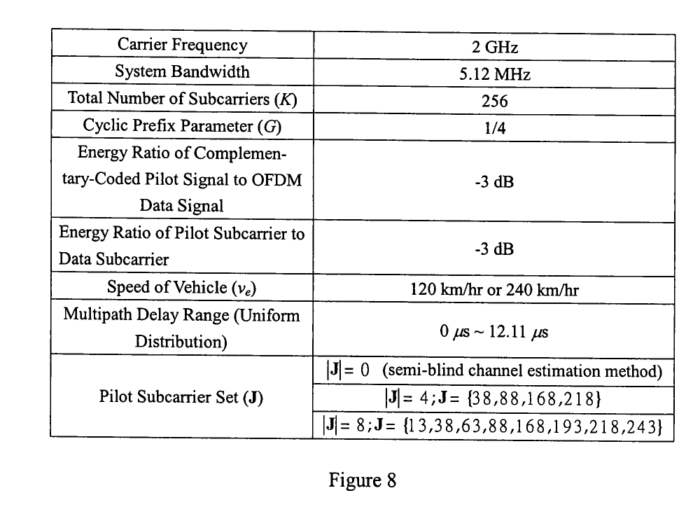

{Qᵢ:i=l·2^{S}^{_{D}}, for l=0,1 . . . , └(|Q|−1)/2^{S}^{_{D}}┘}

where S_{D} is an integer that is larger than or equal to 0, and └□┘ is a floor function. The complementary-coded pilot preambles are described the same as the prior art [B8]. The number of pilot subcarriers, |J|, in an OFDM symbol can be 0, 4, or 8. Additionally, refer to FIG. 8 for other relevant system simulation parameters and conditions.

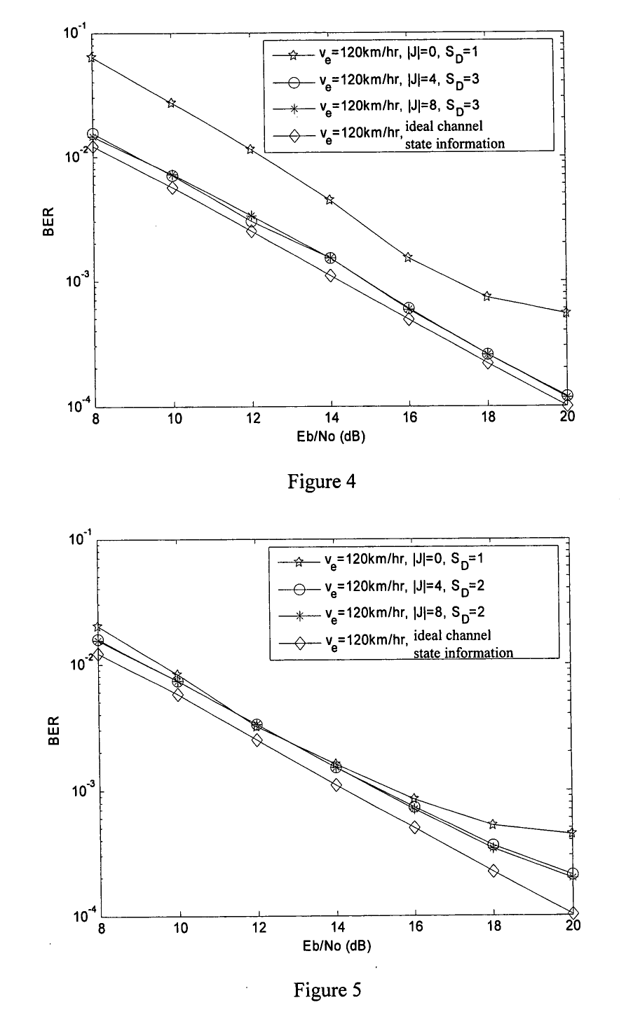

With reference to FIG. 4 and FIG. 5, it can be seen that, when |J|=8 or |J|=4, the speed of the vehicle is 120 km/hr, and the BER is 10⁻³, for the robust semi-blind channel estimation method used in the two-path fading channel shown in FIG. 4 and used in the Veh.-B six-path fading channel shown in FIG. 5, there are respectively only 0.5 dB and 0.7 dB gap in the bit energy to noise power spectrum density ratio (E_{b}/N₀) performance as compared with the ideal channel estimation.

On the other hand, if the speed of the vehicle is 120 km/hr and the BER is 10⁻³, for the semi-blind channel estimation method used in the two-path fading channel shown in FIG. 4 and used in the Veh.-B six-path fading channel shown in FIG. 5, there are respectively 2.2 dB and 0.5 dB worse in the bit energy to noise power spectrum density ratio (E_{b}/N₀) performance as compared with the robust semi-blind channel estimation method.

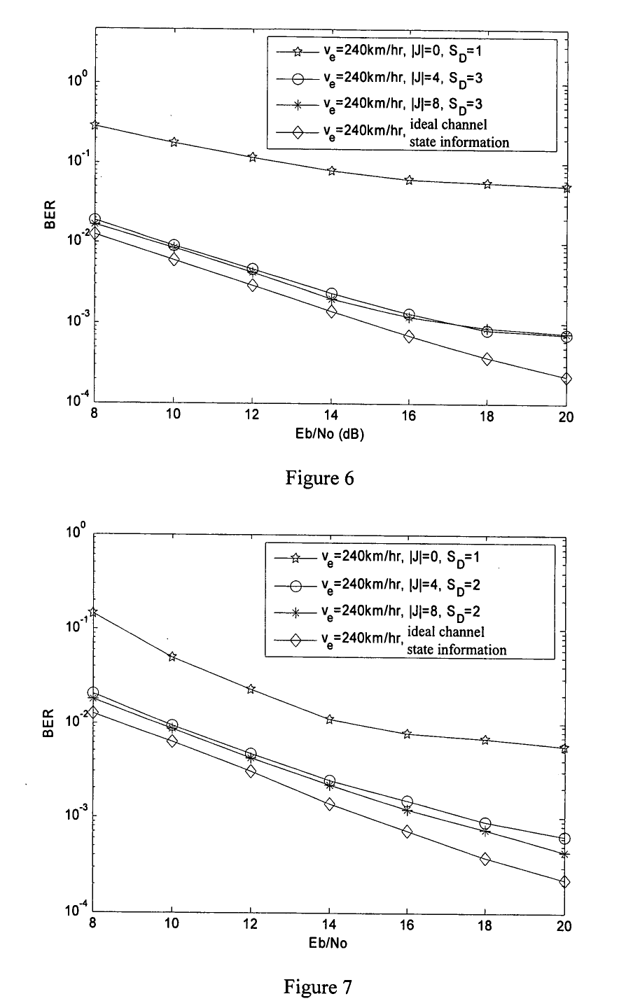

Besides, refer to FIG. 6, which shows the bit error rate for the semi-blind channel estimation and the robust semi-blind channel estimation in the two-path fading channel. If the speed of the vehicle is 240 km/hr and the BER is 10⁻³, it can be seen that, for the robust semi-blind channel estimation method used in the two-path fading channel, there is a 2 dB gap in the bit energy to noise power spectrum density ratio (E_{b}/N₀) performance as compared with the ideal channel estimation.

Also refer to FIG. 7, which shows the bit error rate for the semi-blind channel estimation and the robust semi-blind channel estimation in the Veh.-B six-path fading channel. If the speed of the vehicle is 240 km/hr and the BER is 10⁻³, the required bit energy to noise power spectrum density ratio in the case that the number of pilot subcarriers is 4 (i.e. |J|=4 ) is 0.5 dB higher than the required bit energy to noise power spectrum density ratio in the case that the number of pilot subcarriers is 8 (i.e. |J|=8).

Finally, from the result of simulation, it can be seen that the robust semi-blind channel estimation method proposed in the present invention, while being used in a high vehicular speed (for example, 240 km/hr) environment, exhibits an excellent system performance as compared with the semi-blind channel estimation method.

Although the present invention is disclosed in the preferred embodiments described above, the inventive idea should not be limited only to those. It will be understood by those skilled in the art that various other changes in the form and details may be made without departing from the spirit and scope of the present invention. It is to be understood that various changes may be made in adapting to different embodiments without departing from the broader concepts disclosed herein and comprehended by the claims that follow.

1. A joint channel estimation and data detection method for STBC/OFDM systems, comprising the following steps:
a preliminary step, in which, after passing the received signals through an OFDM demodulator, frequency-domain signals R̅₁[k] and R̅₂[k] of the complementary-coded pilot preambles in two successive OFDM symbol times, as well as two successive OFDM data symbols R₁⁽ⁱ⁾[k] and R₂⁽ⁱ⁾[k] at the ith time slot, are obtained;
an initial step for setting up the predetermined number Nₚ of the channel paths, using complementary-coded pilot preambles to estimate the channel impulse response, then using this estimation result of the channel impulse response to calculate a path selective set Sₘ, and furthermore, in accordance with the path selective set Sₘ, determining the number Lₘ of the selected paths and the excess delay τ_{m,l} of the selected path, and then calculating the initial channel state information vector y^{(1,0)} and the Hessian matrix F;
a tracking step, in which the initial value v of the recursion index is set to 1 at first, and the maximum number of recursion is set to V; then calculate the searching direction vector and update the channel state information vector by y^{(i,v)}=y^{(i,v-1)}−g^{(i,v)} as well as increase the index of recursion by 1; if the index v of recursion is less than or equal to V, repeat the searching of the direction vector and update the channel state information vector; finally, take the channel state information estimated at this time slot to be the initial value of the channel state information at the next time slot, i.e. y^{(i+1,0)}=y^{(i,V)}.

2. A joint channel estimation and data detection method in accordance with claim 1, in which the searching direction vector is given by g^{(i,v)}=(F+λI_{2(L}_{₁}_{+L}_{₂}₎)⁻¹∇f(y^{(i,v-1)}).

3. A joint channel estimation and data detection method in accordance with claim 1, in which, in the tracking step, the extreme point of the cost function is derived by using Newton's method.

4. A joint channel estimation and data detection method in accordance with claim 1, in which, in the tracking step, a new channel estimation can be obtained by continuously executing y^{(i,v)}=y^{(i,v-1)}−g^{(i,v)} in a time slot, where g^{(i,v)} is a searching direction vector.

5. A joint channel estimation and data detection method for STBC/OFDM systems, comprising the following steps:
a preliminary step, in which, after passing the received signals through an OFDM demodulator, frequency-domain signals R̅₁[k] and R̅₂[k] of the complementary-coded pilot preambles in two successive OFDM symbol times, as well as two successive OFDM data symbols R₁⁽ⁱ⁾[k] and R₂⁽ⁱ⁾[k] at the ith time slot, are obtained;
an initial step for setting up the predetermined number Nₚ of the channel paths, using a complementary-coded pilot preambles to estimate the channel impulse response, then using this estimation result of the channel impulse response to calculate a path selective set Sₘ. and furthermore, in accordance with the path selective set Sₘ, determining the number Lₘ of the selected paths and the excess delay τ_{m,l} of the selected path, and then calculating the initial channel state information vector y^{(1,0)} and the Hessian matrix F;
a tracking step, in which the initial value v of the recursion index is set to 1 at first, and the maximum number of recursion is set to V; if the index v of recursion is 1, use sparse pilot subcarriers to calculate channel state information Ĥₘ[k], and calculate a searching direction vector Ψ that is obtained by using the sparse pilot subcarriers, and then calculate a searching direction vector
g^{(i,1)}=μγΨ⁽ⁱ⁾+(1−μ)(F+λI_{2(L}_{₁}_{+L}_{₂}₎)⁻¹∇f(y^{(i,0)})
if the index of recursion is not equal to 1, calculate the searching direction vector as g^{(i,v)}=(F+λI_{2(L}_{₁}_{+L}_{₂}₎)⁻¹∇f(y^{(i,v-1)}); next, update the channel state information vector by y^{(i,v)}=y^{(i,v-1)}−g^{(i,v)}, and increase the index of recursion by 1; if the index v of recursion is less than or equal to V, repeat the searching of the direction vector; finally, take the channel state information estimated at this time slot to be the initial value of the channel state information at the next time slot, i.e. y^{(i+1,0)}=y^{(i,V)}.

6. A joint channel estimation and data detection method in accordance with claim 5, in which, in the tracking step, the frequency-domain response is composed of a plurality of complex sinusoidal waves.

7. A joint channel estimation and data detection method in accordance with claim 5, in which, in the tracking step, Newton's method and data subcarriers are used in the channel estimation so as to achieve the optimization of the joint channel estimation and data detection.

8. A joint channel estimation and data detection method in accordance with claim 5, in which, in the tracking step, a direction vector of the first-order partial derivative of a maximum likelihood function formed by sparse pilot subcarriers is used to serve as a reference for tracking the direction of the channel variation.

9. A joint channel estimation and data detection method in accordance with claim 5, in which, in the tracking step, sparse pilot subcarriers inside an OFDM symbol are used by the channel estimation method in order to calculate a searching direction vector at the first recursion.

10. A joint channel estimation and data detection method for OFDM systems, comprising the following steps:
a preliminary step, in which, after passing the received signals through an OFDM demodulator, a frequency-domain signal R̅[k] of the pilot preamble at an OFDM symbol time, as well as an OFDM data symbol R⁽ⁱ⁾[k] at the ith time slot, are obtained;
an initial step for setting up the predetermined number Nₚ of the channel paths, using a pilot preamble to estimate the channel impulse response, then using this estimation result of the channel impulse response to calculate a path selective set S, and furthermore, in accordance with the path selective set S, determining the number L of the selected paths and the excess delay τₗ of the selected path, and then calculating the initial channel state information vector y^{(1,0)} and the Hessian matrix F;
A tracking step, in which the initial value v of the recursion index is set to 1 at first, and the maximum number of recursion is set to V; then calculate the searching direction vector and update the channel state information vector by y^{(i,v)}=y^{(i,v-1)}−g^{(i,v)} as well as increase the index of recursion by 1; if the index v of recursion is less than or equal to V, repeat the searching of the direction vector and update the channel state information vector; finally, take the channel state information estimated at this time slot to be the initial value of the channel state information at the next time slot, i.e. y^{(i+1,0)}=y^{(i,V)}.

11. A joint channel estimation and data detection method in accordance with claim 10, in which the searching direction vector is given by g^{(i,v)}=(F+λI_{2L})⁻¹∇f(y^{(i,v-1)}).

12. A joint channel estimation and data detection method in accordance with claim 10, in which, in the tracking step, the extreme point of the cost function is derived by using Newton's method.

13. A joint channel estimation and data detection method in accordance with claim 10, in which, in the tracking step, a new channel estimation can be obtained by continuously executing y^{(i,v)}=y^{(i,v-1)}−g^{(i,v)} in a time slot, where g^{(i,v)} is a searching direction vector.

14. A joint channel estimation and data detection method for OFDM systems, comprising the following steps:
a preliminary step, in which, after passing the received signals through an OFDM demodulator, a frequency-domain signal R̅[k] of the pilot preamble at an OFDM symbol time, as well as an OFDM data symbol R⁽ⁱ⁾[k] at the ith time slot, are obtained;
an initial step for setting up the predetermined number Nₚ of the channel paths, using a pilot preamble to estimate the channel impulse response, then using this estimation result of the channel impulse response to calculate a path selective set S, and furthermore, in accordance with the path selective set S, determining the number L of the selected paths and the excess delay τₗ of the selected path, and then calculating the initial channel state information vector y^{(1,0)} and the Hessian matrix F;
A tracking step, in which the initial value v of the recursion index is set to 1 at first, and the maximum number of recursion is set to V; if the index v of recursion is 1, use sparse pilot subcarrier to calculate channel state information Ĥ[k], and calculate a searching direction vector Ψ that is obtained by using the sparse pilot subcarriers, and then calculate a searching direction vector
g^{(i,1)}=μγΨ⁽ⁱ⁾+(1−μ)(F+λI_{2L})⁻¹∇f(y^{(i,0)})
if the index of recursion is not equal to 1, calculate the searching direction vector as g^{(i,v)}=(F+λI_{2L})⁻¹∇f(y^{(i,v-1)}); next, update the channel state information vector by y^{(i,v)}=y^{(i,v-1)}−g^{(i,v)} and increase the index of recursion by 1; if the index v of recursion is less than or equal to V, repeat the searching of the direction vector; finally, take the channel state information estimated at this time slot to be the initial value of the channel state information at the next time slot, i.e. y^{(i+1,0)}=y^{(i,v)}.

15. A joint channel estimation and data detection method in accordance with claim 14, in which, in the tracking step, the frequency-domain response is composed of a plurality of complex sinusoidal waves.

16. A joint channel estimation and data detection method in accordance with claim 14, in which, in the tracking step, Newton's method and data subcarriers are used in the channel estimation so as to achieve the optimization of the joint channel estimation and data detection.

17. A joint channel estimation and data detection method in accordance with claim 14, in which, in the tracking step, a direction vector of the first-order partial derivative of a maximum likelihood function formed by sparse pilot subcarriers is used to serve as a reference for tracking the direction of the channel variation.

18. A joint channel estimation and data detection method in accordance with claim 14, in which, in the tracking step, sparse pilot subcarriers inside an OFDM symbol are used by the channel estimation method in order to calculate a searching direction vector at the first recursion.
